(19) United States
(12) Patent Application Publication
(10) Pub. No.: US 2010/0038041 A1
(43) Pub. Date: Feb. 18, 2010

(54) SUSPENSION PULLEY STRUCTURE FOR MOVABLE PARTITIONS

(76) Inventor: Shou-Hsing Liao, Taichung City (TW)

Correspondence Address: APEX JURIS, PLLC, 12733 LAKE CITY WAY NORTHEAST, SEATTLE, WA, 98125, US

(21) Appl. No.: 12/191,860

(22) Filed: Aug. 14, 2008

(51) Int. Cl. E05D 15/06

(52) U.S. Cl. 160/196.1

(57) ABSTRACT

A suspension pulley structure for movable partitions of the present application which is mounted on a track includes a wheel seat having a pendent axis penetrating therethrough for locking with a door plank, wherein two guiding wheels are pivoted on the bottom of the wheel seat for moving along the track, the right and left sides of the wheel seat are both pivotally connected with rolling wheels for rolling on the inner bottom wall of the track, the wheel seat has an indentation port for accommodating a hanger shaft head at the top of the pendent axis and the indentation port is sealed by a guiding plate, and the pendent axis is connected with the wheel seat through a thrust bearing. Moreover, the top surface of the guiding plate has one side higher than the opposite side with each side has two guiding wheels at the front and rear ends.

### FIELD OF THE INVENTION

The present application is related to a suspension pulley on a partition door, and more particularly to a pulley structure which can guide the door plank from a single track to a dual track so as to gather plural door planks together.

### BACKGROUND OF THE INVENTION

Usually, many markets or restaurants need to use movable partitions for forming temporary wall(s) so as to separate one space into two or to confine an isolated room. As to the ceiling, it has to equip with tracks for hanging partitions, and further, pulley also has to be mounted between the track and the partitions for folding and unfolding the partitions. Since partitions are usually made of wood, glass or fireproof board, after folding up, all the partitions must have to occupy a certain width. Generally, the track is formed to be straight, so that the partitions only can be pushed aside for being folded up. But, because different places have different layouts, the partitions always have to be gathered to a predetermined place for preventing from obstructing the view, and further, the track at the predetermined place must be bent and then forms a dual track, so that the partitions can be guided to turn toward one side and then go into the dual track for being gathered together. Since the partitions are quite heavy, it is better that the rolling wheels on the track can provide a stable and smooth rolling without jumping, especially at the turning point, so that the rolling wheels can smoothly guide the partitions to turn toward one side and enter the dual track for gathering together.

### SUMMARY OF THE INVENTION

The object of the present application is to provide a suspension pulley structure for movable partitions which can be applied to all kinds of tracks for gathering door planks, wherein two guiding wheels are mounted on the bottom at the front end and the rear end for smoothing the moving along the track and the turning slide rail, and guiding wheels are mounted on the top guiding plate at the left and the right sides for rejecting against the inner walls of the track and the slide rail so as to position the wheel seat and provide stability, especially at the turning point.

For achieving the object described above, the present application provides a suspension pulley structure for movable partitions mounted on a track on the ceiling including a wheel seat sleeved in the track and penetrated through a pendent axis, which is locked with a door plank. The wheel seat has two guiding wheels mounted on the bottom at the front and the rear ends thereof for moving along the track, the right and the left sides of the wheel seat both have a pair of rolling wheels pivotally mounted thereon for rolling on the inner bottom wall of the track, and the rolling wheels are pivoted with the spindles of the wheel seat through a bearing. Moreover, the pendent axis has a hanger shaft head at the top thereof, the hanger shaft head is accommodated in an indentation port of the wheel seat, the pendent axis is further sleeved by a thrust bearing for smoothly turning the wheel seat, and the top of the wheel seat is locked with a guiding plate for limiting the upward rejection of the pendent axis. Furthermore, the top surface of the guiding plate has one side higher than the opposite side with each side has a pair of guiding wheels pivoted thereon. Besides, the track has a slide rail mounted at the turning point, the slide rail has a division protruded on the inner top wall thereof for isolating a guiding slot through cooperating with one inner side wall of the slide rail, and the guiding slot can guide the two guiding wheels protruded on one side of the guiding plate to enter, thereby guiding the wheel seat to turn and enter the track for gathering the door planks.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 is a three-dimensional decomposition drawing showing the present application in a preferred embodiment;

FIG. 2 is another three-dimensional decomposition drawing showing the present application in a preferred embodiment;

FIG. 3 is a sectional view showing the present application in a preferred embodiment;

FIG. 4 is a schematic view showing the present application in a preferred embodiment;

FIG. 5 is a three-dimensional decomposition drawing showing the present application in another preferred embodiment;

FIG. 6 is another three-dimensional decomposition drawing showing the present application in another preferred embodiment;

FIG. 7 is a schematic view showing the track and the folded up partitions in a preferred embodiment according to the present application; and

FIG. 8 is a schematic view showing the track and the folded up partitions in another preferred embodiment according to the present application.

### DESCRIPTION OF THE PREFERRED EMBODIMENT

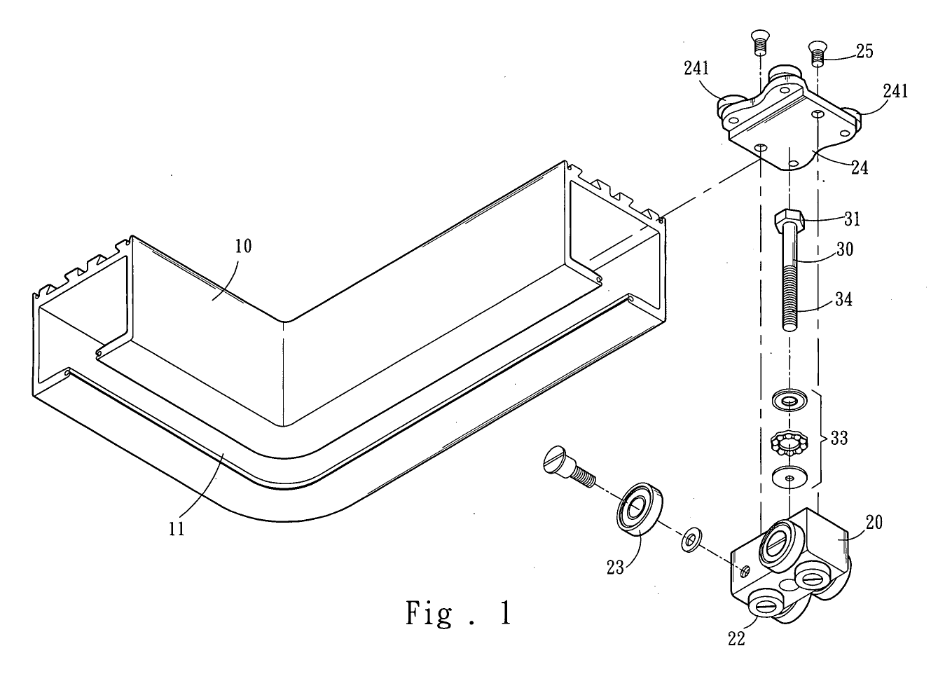

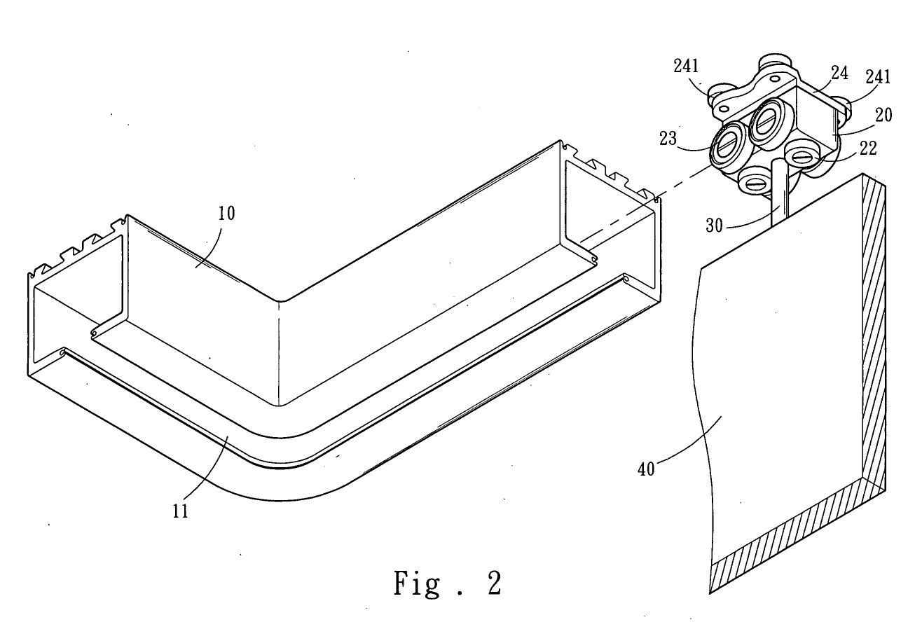

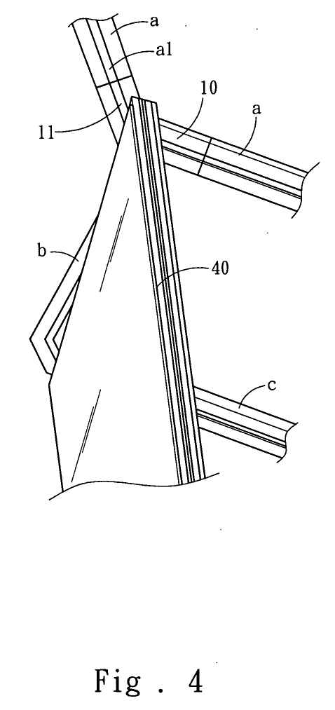

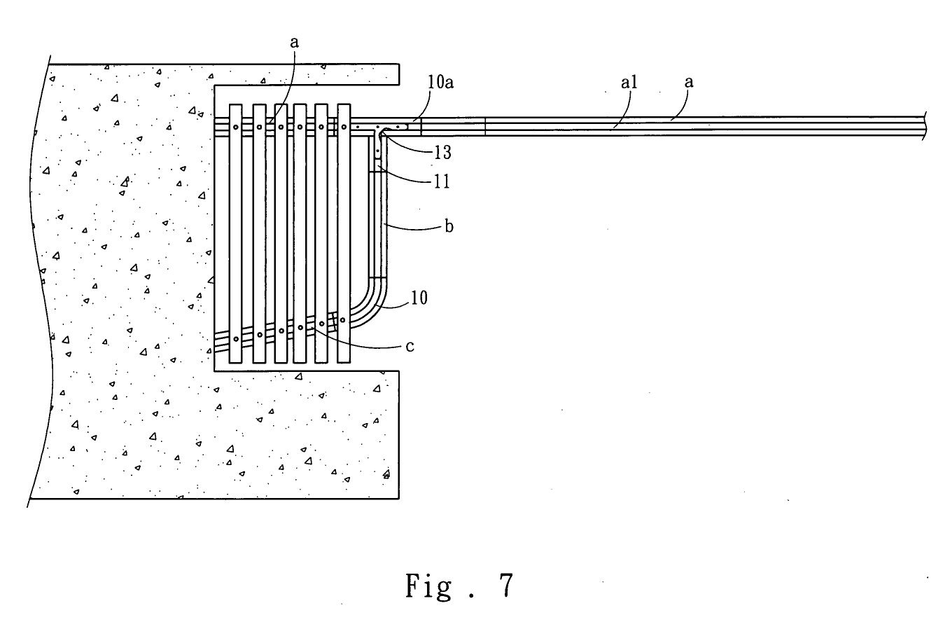

Please refer to FIG. 1 and FIG. 2. A suspension pulley structure for movable partition of the present application is mounted on a track a, as shown in FIG. 4 and FIG. 7, so as to hang a door plank 40 on the track a. The track a is a track which is changed from single track to dual track and has a rail slot al at the bottom thereof and an L-shaped slide rail 10 located at the turn portion thereof. The bottom of the slide rail 10 has mounted thereon another rail slot 11, and the width of the rail slot 11 is smaller than the inner space of the slide rail 10. The suspension pulley structure includes:

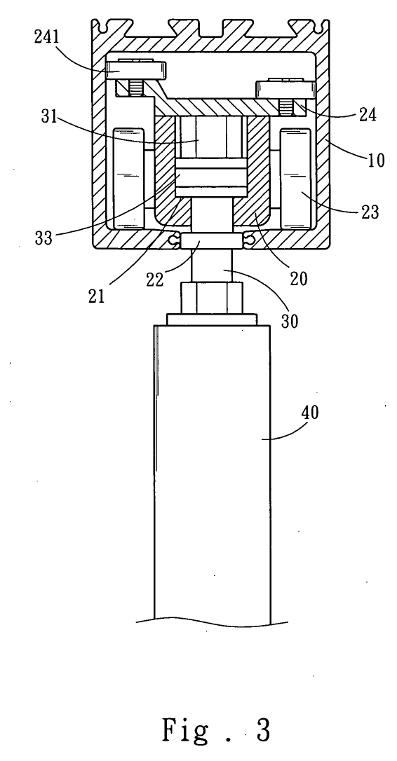

A block wheel seat 20, sleeved in the slide rail 10 and having an indentation port 21, wherein as shown in FIG. 3, the wheel seat 20 has two guiding wheels 22 pivotally mounted at the bottom thereof and respectively at the front end and the rear thereof, two spindles respectively mounted at the right side and also the left side thereof, a rolling wheel 23 pivotally connected to each spindle at the outer side, a bearing connected between the rolling wheel 23 and the spindle, and a guiding plate 24 which is located at the top of the wheel seat 20 and is locked with the wheel seat 20 by two bolts 25.

A pendent axis 30, which is downwardly extended from the indentation port 21 at the top of the wheel seat 20 and penetrates through the rail slot al of the track a and the rail slot 11 of the slide rail 10, wherein the pendent axis 30 has a hanger shaft head 31 at the top thereof, the hanger shaft head 31 is accommodated in the indentation port 21 for internally sleeving to a thrust bearing 33, the pendent axis 30 penetrates through the center of the thrust bearing 33, the guiding plate 24 covers the top of the wheel seat 20 for sealing the indentation port 21 and is locked with the wheel seat through two bolts 25 at the front end and the rear end, and the pendent axis 30 has a thread section 34 at the lower end thereof.

Wherein the top surface of the guiding plate 24 has one side higher than the opposite side and the two sides respectively have two guiding wheels 241 pivotally mounted thereon.

Thereby, the thread sections 34 respectively on two pendent axes 30 under two wheel seats 20 can lock with the top of a door plank 40, the guiding wheels 22 of the two wheel seats 20 can move along the rail slot al of the track a, as shown in FIG. 4 to FIG. 7, and turn along the rail slot 11 of the slide rail 10, and two pairs of rolling wheels 23 respectively located at the right side and the left side of the wheel seat 20 can respectively cross the two portions of the inner bottom wall of the track a and roll on the inner bottom wall of the slide rail 10, as shown in FIG. 3, so that the door plank 40 can move on along the track a, enter the slide rail 10 to turn, as shown in FIG. 4, and be guided to enter the dual track.

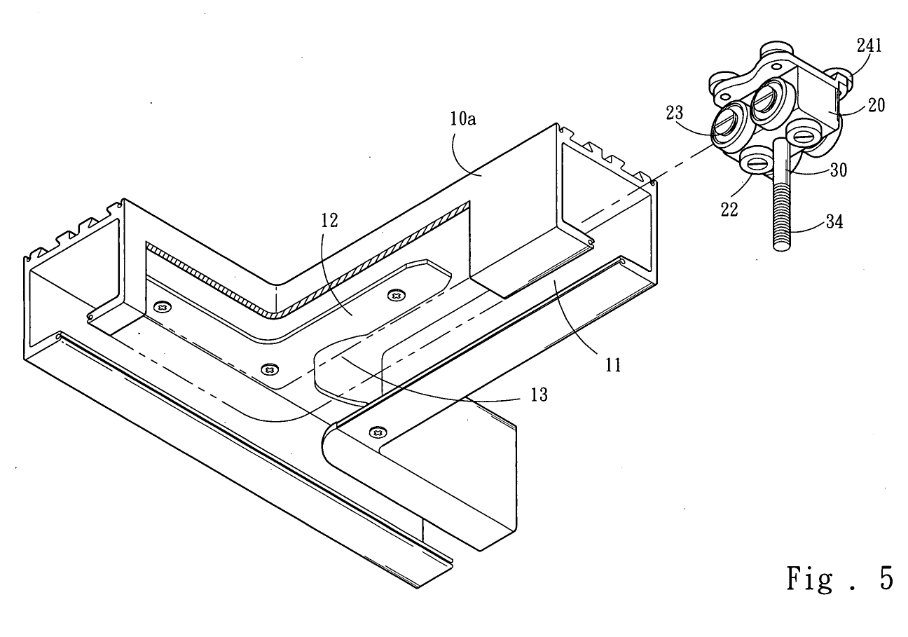

Moreover, in the present application, the two guiding wheels 241 on the higher portion of the top of the guiding plate 24 can be assembled with the T-shaped slide rail 10a, as shown in FIG. 5. The inner top wall of the slide rail 10a has a division 12 protruded thereon for isolating a guiding slot 13 by cooperating with the right side inner side wall of the slide rail 10. The guiding slot 13 can guide the two guiding wheels 241 protruded on the right side top of the guiding plate 24 to turn right the wheel seat 20 and guide the door planks 40 toward the predetermined direction for gathering. Besides, the two lower guiding wheels 241 at the left side top of the guiding plate 24 can achieve the positioning function for rejecting against the side wall of the slide rail 10a so as to prevent the door plank 40 from swaying.

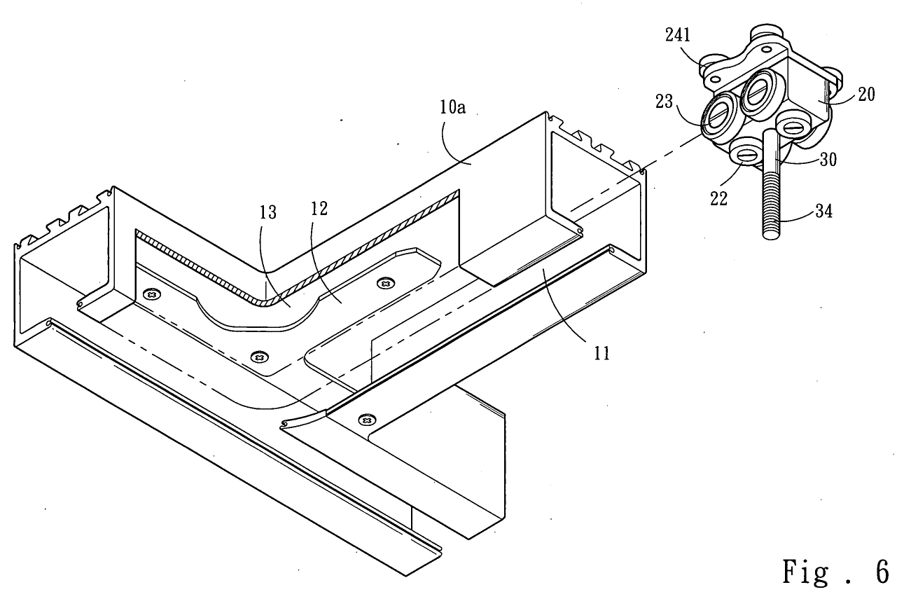

If the user wants to alter the gathering direction of the door planks 40 as the left side, as shown in FIG. 6, the wheel seat 20 can be taken out, turned a direction and re-assembled, so that the two higher guiding wheels 241 may become to locate at the left side, and further, the division 12 also can be detached, turned a direction and re-locked on the slide rail 10a, so that the guiding slot 13 may become to locate at the left side for guiding the left side guiding wheels 241 of the wheel seat 20 to turn left and gathering the door planks 40 to the left side.

Please refer to FIG. 7. The track a is changed from single track to dual track and a T-shaped slide rail 10a and a slide rail 10 of 1350 are mounted at the turning point, so that through the slide rail 10a guiding the wheel seat 20 at the front end of the door plank 40 to turn into the track b and then the track c, the other wheel seat 20 at the rear end can directly and straightly enter the track a, thereby turning the door planks 40 and gathering them together.

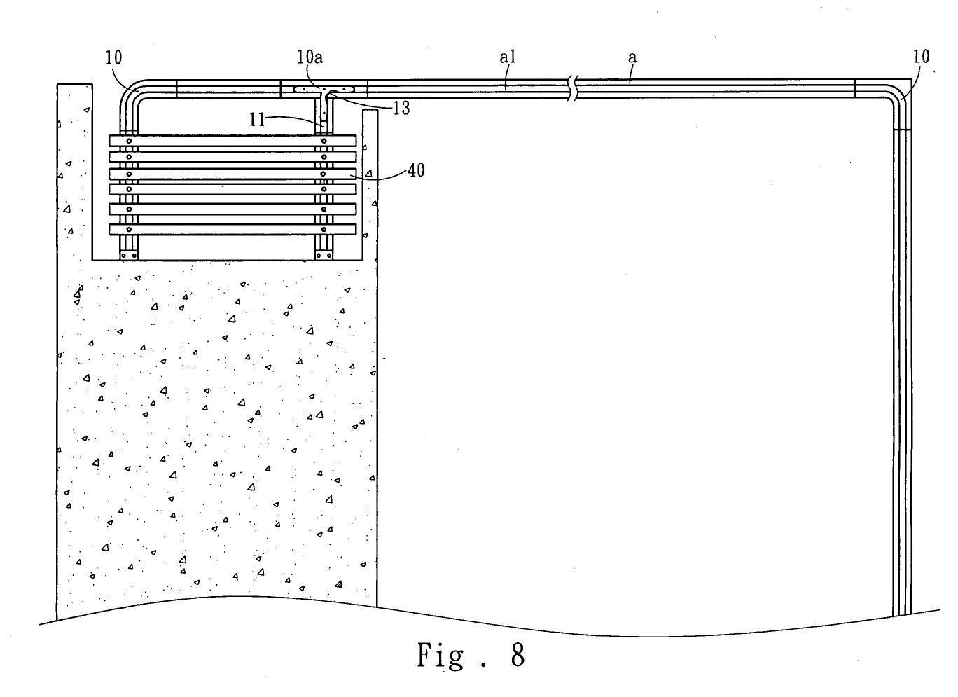

Since in the present application, two wheel seats 20 which are pivoted to one single door plank 40 can be turned freely and respectively, so that the door plank 40 can be moved along different types of track a, and thus, the two wheel seats 20 on the top of the door plank 40 can be guided into all kinds of liner tracks and then guided into the dual track, so as to gather together. In addition, the slide rail 10 can have an L shape of 90° to combine with a T-shaped slide rail 10a, so as to be used in the outlay as shown in FIG. 8.

In the aforesaid, the present application is advantageous that:

1. The spindles at the right and the left sides of the wheel seat 20 are sleeved with bearings, which are respectively connected with the rolling wheel 23, and the respective two rolling wheels 23 at the left and the right sides can mount on two portions of the inner bottom wall of the track a, so that the wheel seat 20 can have an easy moving, and further, the wheel seat 20 also has two guiding wheels 22 at the front and the rear ends and four guiding wheels 241 on the top for rejecting against the inner portion of the track a, so as to stabilize the rolling and prevent from swaying.

2. A thrust bearing 33 is mounted between the wheel seat 20 and the pendent axis 30, so that the wheel seat 20 can have a nimble move along the slide rail 10, thereby facilitating the folding and unfolding of the door planks 40. Furthermore, the guiding plate 24 and the wheel seat 20 are locked together for providing sufficient intensity, so that it can avoid the pendent axis 30 and the door planks 40 from being pushed upward and also provide the anti-theft capability.

3. The two sides of the guiding plate 24 on the top of the wheel seat 20 have different heights, so that the two guiding wheels 241 on the higher top can turn along the guiding slot 13 inside the slide rail 10a, thereby it can be applied to T-shaped slide rail 10a for providing smooth rolling and moving.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A suspension pulley structure for movable partitions, mounted on a track for moving a door plank, wherein the track has a rail slot at the bottom thereof and an L-shaped slide rail located at the turn portion thereof, and the bottom of the slide rail has mounted another rail slot, comprising:
a wheel seat, sleeved in the track, turned through the slide rail and penetrated by a pendent axis, characterized in that the pendent axis has a hanger shaft head at the top thereof and the wheel seat has an indentation port for accommodating the hanger shaft head, the wheel seat has a guiding plate at the top thereof and the top surface of the guiding plate has one side higher than the opposite side with each side has two guiding wheels at the front and the rear ends, the pendent axis penetrates through the track and the slide rail for connecting with the top of the door plank, two guiding wheels are pivoted on the bottom of the wheel seat at the front and the rear ends, the guiding wheels are rotating in the rail slot of the track and the rail slot of the slide rail, the right side and the left side of the wheel seat are both pivotally connected with at least two rolling wheels, and the rolling wheels are mounted and rolled on the inner bottom wall of the track and enter the slide rail.

2. The suspension pulley structure as claimed in claim 1, characterized in that the slide rail has an angle of 90° or larger than 90°.

3. The suspension pulley structure as claimed in claim 1, characterized in that the T-shaped slide rail has a division protruded on the inner top wall thereof for isolating a guiding slot through cooperating with one inner side wall of the slide rail, and the guiding slot guides two guiding wheels protruded on one side of the guiding plate to enter.

4. The suspension pulley structure as claimed in claim 1, characterized in that the indentation port of the wheel seat is assembled with a thrust bearing and the pendent axis penetrates through the center of the thrust bearing.

5. The suspension pulley structure as claimed in claim 1, characterized in that the right side and the left side of the wheel seat both have two spindles mounted thereon, and the spindle is pivotally connected with the rolling wheel through a bearing.

6. The suspension pulley structure as claimed in claim 1, characterized in that the track is changed from single track to dual track.
